(19) United States
(12) Patent Application Publication
(10) Pub. No.: US 2015/0356017 A1
(43) Pub. Date: Dec. 10, 2015

(54) PREDICTIVE CACHE APPARATUS AND METHOD OF CACHE PREDICTION

(71) Applicant: HEWLETT-PACKARD DEVELOPMENT COMPANY L.P., Houston, TX (US)

(72) Inventors: Vincent Planat, Saint-Egreve (FR); Remi Verney, Grenoble (FR); Francois-Xavier Kowalski, Grenoble (FR)

(21) Appl. No.: 14/759,945

(22) PCT Filed: Jan. 31, 2013
(86) PCT No.: PCT/IB2013/000348

§ 371 Date: Jul. 9, 2015

(51) Int. Cl. G06F 12/08

(52) U.S. Cl. CPC G06F 12/0862; G06F 2212/1024; G06F 2212/163; G06F 2212/602

(57) ABSTRACT

The present disclosure discloses a predictive cache apparatus particularly but not exclusively for controlling the cache update of a database, the predictive cache apparatus including a CEP processor configured to detect events generated the database or operational units, and to generate a cache operation order based on detected events, and a cache distributor configured to control the data to be cached in cache units based on the cache operation order generated by the CEP processor. The disclosure also discloses a method of cache prediction that can be implemented by such a predictive cache apparatus.

### BACKGROUND

The desire to offer a more customer-centric experience is causing many large companies to consolidate their existing customer data into a single operational database and to augment that centralized database with additional customer data obtained from various sources such as social networking services, partner systems, analytic systems, etc. The goal for such companies is to use that consolidated data in order to personalize existing or new services, to identify attractive new service offerings, and to offer their customers a seamless experience across all touch points.

However, as the number of operational systems and customer touch points that access that data increases, the overall database system can turn into a performance bottleneck, thereby resulting in a poor user-experience. In particular, database systems based on Oracle Hub™ technology for instance suffer from high latency on front line operation for critical data. Direct access to such centralized operation database from front line systems cannot be envisioned for deployment.

The present disclosure relates to a new predictive cache apparatus and to a method of cache prediction.

### BRIEF DESCRIPTION OF THE DRAWINGS

FIG. 1 is schematic view showing the hardware architecture of an operational system (including a predictive cache apparatus) according to a particular example of the present disclosure.

FIG. 2 shows an example of sequence diagram of the main steps that can be carried out by the operational system (in particular, the predictive cache apparatus) of FIG. 1 to implement a particular example of the present disclosure.

### DETAILED DESCRIPTION

One performance problem when using centralized operational databases is the time required to fetch objects from the database into a local cache as they are demanded. In some instances, the cache dedicated to some operational systems can also get full.

Therefore, data access to existing operational databases is not always satisfactory and there is in particular a need for improving the relevance of cache updates in such systems. An object of the present disclosure is to optimize the cache update of a database on the basis of events that are produced by operational systems deployed in the system and/or by the database itself.

The present disclosure discloses a predictive cache apparatus arranged to control, based on a complex processing event (CPE) technology, the cache update of a database. The CEP technology can for instance enables processing that combines events produced by operational systems to infer more complicated patterns. Based on an analysis of at least one detected event and on a pattern inferred from this detected event, it is possible to obtain insight of a current situation and to trigger a cache update adapted to that particular situation.

In a particular aspect of the present disclosure, the cache update can for instance be optimized by correlating various events that can be generated either by operational units (or operational systems) and/or by the database, and by leveraging a CEP processor providing an extended rule definition language (EPL for “Event Processing Language”).

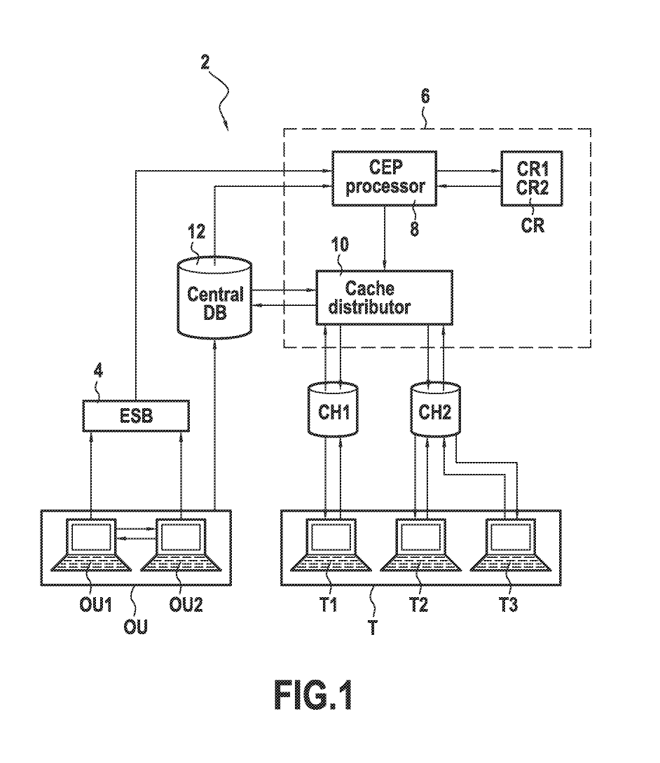

The present disclosure discloses hereafter an example of hardware implementation in reference to FIG. 1. In this particular example, an operational system 2 includes:
a predictive cache apparatus 6;
a plurality of operational units OU1 and OU2 (referenced collectively as OU);
a database 12;
cache units CH1 and CH2 (referenced collectively as CH); and
terminals T1, T2 and T3 (referenced collectively as T).

The predictive cache apparatus 6 is arranged to control the cache update of database 12 to which the predictive cache apparatus is connected.

More specifically, there are two operational units OU in this example. These OU can correspond for instance to applications (or services) deployed in the operational system 2. It should however be understood that there can be a number N of operational units deployed in the operational system 2, where N is an integer such that N≧1.

These operational units may be mobile devices or interactive terminals used by an end-user (a user terminal in an airport for instance) or an operational system used by operators.

These operational units OU can interact with the CEP processor 8 via an interface 4 described in more details hereafter. In addition, each operational unit OU may communicate with the central database 12 to update or delete existing data stored in database 12 and/or to add new data into database 12. The operational units OU may communicate with the CEP processor 8 and the central database 12 through a firewall.

Each operational unit OU is capable of producing events which take the form of messages. Each event produced by an operational unit provides information about a particular situation. An event may for instance correspond to a notification, a command or a request transmitted by an operational unit OU. Events can also be produced by database 12. In one example, database 12 can produce events indicative of a change of state of a particular data item stored in database 12. Such a change of state may result from a data upload performed by an operational unit OU, for instance.

In a particular aspect of the present disclosure, each generated event contains an identifier identifying the database 12 or to the operational unit OU from which it originates.

In the present example, database 12 is a centralized customer database 12 in which data items related for instance to customer data can be stored in a single place. Customer data such as demographics, groups, peoples etc. may all be federated into the operational database 12.

The predictive cache apparatus 6 of the present example includes:
a CEP processor 8 connected with each of the operational units OU via an interface 4, and
a cache distributor 10 connected to the cache units CH1 and CH2, to the CEP processor 8 and to the database 12.

The CEP controller 10 can for example be based on Esper™ technology. In the present case, it is assumed that CEP processor 10 is an Esper™ CEP-based engine.

In the present example, the CEP processor 10 is connected via an Enterprise Service Bus (ESB) to each operational system OU, although the use of an ESB is not mandatory. The ESB interface 4 can be based, for instance, on a Jboss™ software architecture. Using an ESB enables communications between the operational units OU and the CEP processor 8 of the predictive cache apparatus 6 in a service-oriented architecture (SOA). An ESB may for instance translate an event (or a message) produced by an operational unit OU into an appropriate message format and transmit it to the CEP processor 10 (content based-routing).

As mentioned above, the predictive cache apparatus 6 is connected to two cache units CH1 and CH2. One of the cache units CH is assigned to each terminal T1, T2 and T3. In the present example, terminal 1 can interrogate cache unit CH1 to access data stored in CH1 while terminals T2 and T3 can interrogate cache unit CH2 to access data stored in CH2.

The number of cache units may of course vary depending on the number of terminals deployed in the operational system 2. It should be understood that a dedicated cache unit could be associated to each terminal T. In other cases, terminals may share a same cache unit.

The CEP processor 8 is arranged to detect events generated by the operational units OU and by database 12. The CEP processor 8 analyses the events continuously, this analysis being for example real-time or near real-time.

In one aspect of the present disclosure, the analysis is performed on the basis of a predetermined set of correlation rules CR. In this case, the rules CR are stored in the predictive cache apparatus 6 itself, although this is not mandatory. In other cases, the set of rules CR may be external to the predictive cache apparatus 6 provided that the CEP processor is capable of consulting the correlating rules CR when needed. In the present example, two correlation rules CR1 and CR2 are included in the set CR for the purpose of illustration only.

In one example, the event analysis performed by the CEP processor 8 includes the search for predetermined events by filtering through the various events that may originate from the operational units OU and from database 12. The CEP processor 8 may for example detect a predetermined relationship between detected events. In other cases, analysis of at least one event as a function of time may be performed (time-based event).

In an aspect of the present disclosure, the CEP processor 8 identifies, based on detected events, predetermined event patterns by applying the correlation rules CR.

In one example, the CEP processor 8 includes an internal memory to temporarily store events coming from the operational units OU and from database 12.

According to the present disclosure, the CEP processor 8 is arranged to generate a cache operation order based on at least one detected event produced by database 8 or by an operational unit OU. An object of this cache operation order is to trigger a cache update in a particular cache unit CH. A cache operation order is for instance a set of software instructions that can be read by a computer or the like.

In a particular example of the present disclosure, the CEP processor 8 is configured to generate cache operation orders based on at least one detected event generated by an operational unit OU only (i.e. the events that may be generated by the database 12 are not taken into account in the process of generating the cache operation order).

In one aspect of the disclosure, each cache operation order generated by the CEP processor 8 includes the following parameters:
an identifier of the cache unit where a cache operation is to be performed;
the nature of the cache operation to be performed (e.g. “create” for adding new data, “delete” for deleting existing data, and “modify” for modifying existing data);

Depending on the type of cache operation which is instructed, a cache operation order may also include:
an identifier (a resource URL for instance) of data item(s) stored in database 12 which is/are to be used for performing the data cache operation (in the case of a creation or update of a data item in the designated cache unit CH); or
an identifier of a data item which is to be deleted in the designated cache unit CH.

A cache operation order may also contain a cache duration parameter indicating the duration of validity of a data item which is to be cached in the appropriate cache unit CH. The cache units CH may be configured to delete the concerned data item when the validity expires.

In one aspect of the present disclosure, the correlation rules CR are defined using an event processing language (EPL). For instance, each correlation rule may define at least one predetermined event and a corresponding cache operation order that CEP processor 10 is to generate upon detection of said predefined event.

More generally, each correlating rule may contain at least one condition related to a detected event and a predetermined action to be carried out by the CEP processor 10 when all the conditions are met.

The cache distributor 10 controls the data to be cached (the cache update) in each of the cache unit CH on the basis of generated cache operation orders that it may receive from CEP processor 8. The cache distributor 10 converts a received cache operation order into a command (or respective commands) which is then sent to any appropriate cache unit CH where a cache update is required.

The cache control performed by the cache distributor 10 may for instance include at least one among the following:
retrieving a particular data item from the database 12 and sending a first command including the retrieved data item to an appropriate cache unit CH (to order the update of a data item already stored in the cache unit based on the retrieved data item, or to add the retrieved data item into the cache unit); and
sending a second command to an appropriate cache unit to order deletion of a particular data item stored in the cache unit, this command including an identifier of the data item which is to be deleted.

In one example, the cache distributor 10 may also generate and maintain up-to-date a map of the cached data which is stored in each respective cache unit CH. The cache map can be updated by the cache distributor 10 at a regular basis (e.g. at a predetermined time step).

A cache operation order received from the CEP processor 8 may for instance cause the cache distributor 10 to trigger the caching of selected subsets of data items initially stored in database 12. Based on a cache operation order, the cache distributor 10 may also trigger the deletion (or invalidation) or update of existing data items already cached in a particular cache unit CH and/or the creation of new data items to be cached in a particular cache unit CH.

All retention policies may for instance be implemented by an ehCache API in the cache units CH.

The correlation rules CR are for instance defined to optimize access of operational units OU to data items that they are likely to request when predetermined events occur. The data items likely to be needed by each operational unit OU can be advantageously cached in advance into each appropriate cache unit CH.

In other words, the cache prediction contemplated in the present disclosure allows determining which data items should be prefetched from database 12. By performing a cache prediction based an analysis of detected events against predetermined correlating rules, access to critical data can be significantly enhanced by the cache predictive apparatus of the present disclosure.

According to a particular aspect of the present disclosure, the various steps of a method of cache prediction as described in the present disclosure are carried out by the predictive cache apparatus by running a computer program. The predictive cache apparatus may have for instance a hardware architecture of a computer, including for instance a processor capable of executing each step in cooperation with appropriate memories.

Accordingly, the present disclosure also provides a computer program on a recording medium, this computer program being arranged to be implemented by the predictive cache apparatus, and more generally by a processor, this computer program including instructions adapted for the implementation of a method of cache prediction as described in the present disclosure.

The computer programs of the present disclosure can be expressed in any programming language, and can be in the form of source code, object code, or any intermediary code between source code and object code, such that in a partially-compiled form, for instance, or in any other appropriate form.

The present disclosure also discloses a recording medium readable by the predictive cache apparatus, or more generally by a processor, this recording medium including computer program instructions as mentioned above.

The recording medium previously mentioned can be any entity or device capable of storing the computer program. For example, the recording medium can including a storing means, such as a ROM memory (a CD-ROM or a ROM implemented in a microelectronic circuit), or a magnetic storing means such as a floppy disk or a hard disk for instance. In the example of FIG. 1, the correlation rules CR are for instance stored in a Flash memory (or EEPROM) included in the predictive cache apparatus.

The recording medium of the invention can correspond to a transmittable medium, such as an electrical or an optical signal, which can be conveyed via an electric or an optic cable, or by radio or any other appropriate means. The computer program according to the invention can in particular be downloaded from the Internet or a network of the like.

Alternatively, the recording medium can correspond to an integrated circuit in which a computer program is loaded, the circuit being adapted to execute or to be used in the execution of the methods of the invention.

The advantages of the present disclosure are multiple and include for example optimizing access of operational units to critical data by performing cache prediction using a CEP processor and by carrying out caching operations based on the results of the cache prediction. By caching the data likely to be requested in the future by operational units, reduction of response latency and optimisation of data access can be achieved. The operational units do not need to interrogate the database 12 to retrieve the necessary data items.

### EXAMPLE

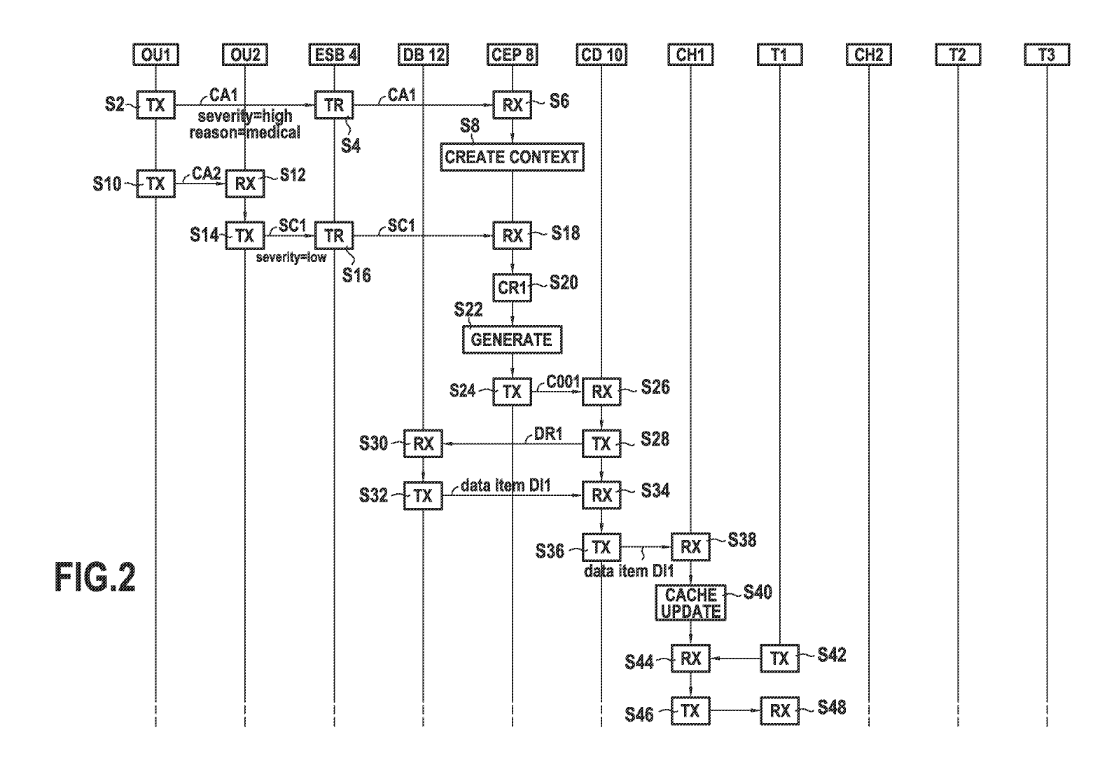

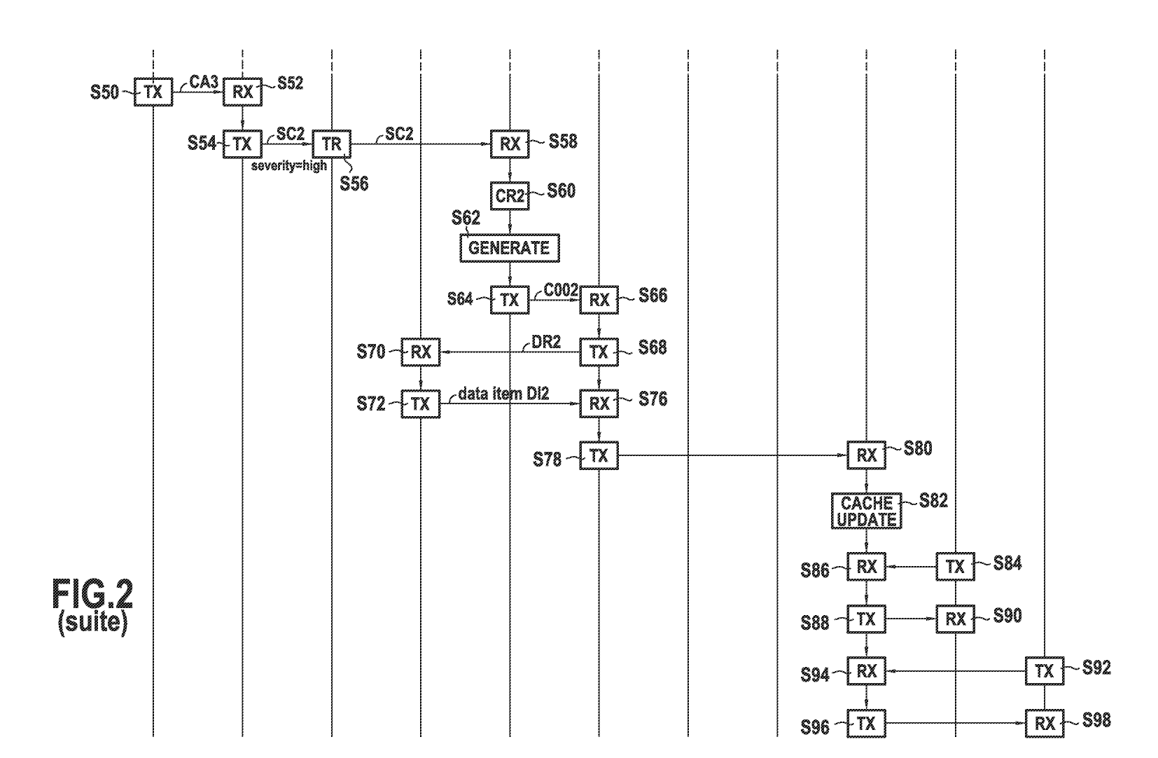

A practical example of implementation of the embodiment illustrated in FIG. 1 is now described in reference to the sequence diagram shown in FIG. 2.

The present example is based on a fictive emergency situation taking place on an air flight. In this example, a passenger of an on-going flight 458 from New York to Miami suddenly falls ill. The crew's head of the aircraft decides to contact an operation supervisor to seek advice as to how this situation should be handled. This results in the operational unit OU1 associated to flight 458 to generate and send (S2) a crew alert CA1 which is transmitted (S4) via ESB 4 to the CEP processor 8. In this example, the crew alert CA1 indicates that the level of severity is high and that the alert concerns a medical issue (severity=high, reason=medical).

Upon reception (S6) of the event CA1 (i.e. the crew alert CA1 generated by OU1), the CEP processor 8 applies the correlation rules CR stored in the predictive cache apparatus 6. At this stage, no cache update is triggered by the correlation rules CR. The CEP processor 8 only keeps (S8) in memory the occurrence of crew alert CA1 (creation of a context).

Upon reception (S12) of an additional crew alert CA2 from the crew's head, the operation supervisor decides to initiate a low level emergency lockout (severity low) for flight 458. This results in the generation and sending (S14) by the operation unit OU2 of a supervisor command SC1 “Low level emergency lockout” which is transmitted (S16) by the ESB 4 and eventually detected (S18) by the CEP processor 8. As lock out is initiated, notification is sent to the designated offices, including the New-York call center support desk that will handle incoming calls.

Upon reception (S18) of the event SC1, the CEP processor 8 applies the correlations rules CR. By applying rule CR1 (S20), the CEP processor 8 is caused to generate a cache operation order COO1, that is, a specific order related to a cache operation which is to be carried out by a cache unit CH. The CEP processor sends the cache operation order COO1 to the cache distributor 10 in step S24.

Once received (S26), the cache distributor 10 processes the cache operation order COO1 to analyse its content. In the present example, the cache operation order COO1 instructs the cache distributor 10 to trigger a cache update in cache unit CH1. More specifically, by sending the cache operation order COO1, the CEP processor 8 commands that specific data (e.g. passenger data of flight 458, such as names, ages . . . ) stored in the database 12 be cached in the cache unit CH1. As a result, cache distributor 10 sends (S28) a data request DR1 to database 12 to retrieve the passenger data needed for the cache update of CH1. In response, database 12 sends back (S32) the requested data items DI1 to the cache distributor 10.

In a particular embodiment, the cache operation order COO1 contains an identifier of the data item (or set of data items) to be retrieved from database 12. This identifier is included in the data request DR1 so that database 12 can determine which data item(s) is/are to be provided with.

Once DI1 received (S34), the cache distributor 10 sends (S36) a command to the cache unit CH1 causing the latter to cache (S40) the retrieved data item DI1. In this example, the command is performed by simply sending DI1 to the cache unit CH1. The cache update S40 allows keeping in cache unit CH1 data items likely to be requested later on by terminal 1 of the New York support desk operator. Should terminal 1 request access to data item DI1, it will be quickly retrieved from cache unit CH1, thereby avoiding any problematic response latency (steps S42-S48). In the present case, only cache unit CH1 is updated with data item DI1, although a similar update could have been triggered in cache unit CH2 so as to facilitate access of T2 (related to Miami support desk support) to DI1.

In practice, the terminals T such as T1, T2 and T3 can for example interrogate the cache units CH through proxies which have been omitted for the sake of clarity.

Still in this example, other passengers of flight 458 start later on to show similar illness symptoms. The crew's head of flight 458 now considers it to be a very serious emergency and causes a new crew alert CA3 to be sent (S50) from operation unit OU1 to the operations supervisor. In response, the operations supervisor initiates a complete flight lockout for flight 458. As a result, operation unit OU2 generates and sends (S54) a supervisor command SC2 (with the parameter severity=high in this case) via ESB 4 to CEP processor 8. As complete lockout is initiated, notifications are sent to the New-York and Miami call center support desks that will handle incoming calls and to the Emergency response group assigned to this situation.

Upon reception (S58) of the event CS2, the CEP processor 8 applies the correlation rules CR. By applying (S60) correlation rule CR2, the CEP processor 8 is caused to generate (S62) a new cache operation order COO2, the goal of which being to trigger into cache units CH1 and CH2 the caching of passenger extended data (medical profile, etc.) related to flight 458. The CEP processor then sends (S64) the cache operation order COO2 which is received by the cache distributor in step S66.

In response to COO2, the cache distributor 10 sends (S68) a new data request DR2 to database 12 to retrieve data items DI2 corresponding to the passenger extended data required for the cache update in cache units CH1 and CH2. Once the data item DI2 is received (S76) from database 12, the cache distributor 10 sends (S78) a command to the cache units CH1 and CH2 causing these cache units to cache (S82) the retrieved data item DI2. For the sake of simplicity, only the cache update in cache unit CH2 is described in the present case. In this example, the command is performed by simply sending DI2 to the cache units CH1 and CH2.

The cache update S82 allows storing into cache unit CH2 data items likely to be consulted later on by terminals 2 and 3 related respectively to New York support desk operator and to the Miami medical team. Should terminal 2 or 3 request access to data item DI2, quick retrieval of DI2 from cache unit CH2 can be achieved, thereby avoiding any problematic response latency (steps S84-S90 and S92-S98).

Hereafter is an example of Esper correlation rules (defined using an EPL) that could be used to implement the CEP processor 8 in the particular example described above in reference to FIG. 2:

```
// CrewAlertStream is an event of stream connect to crewAlert “Operation
System”
// SupervisionStream is an event of stream connect to Airport Supervision
“Operation System”
// Start a new Esper context as soon as we receive a CrewAlertStream
event create context Ctx
  initiated by CrewAlertStream(Severity=“high” and Reason=“medical”)
  as ce terminated after Fly458Duration
// This rule check if, after the crewAlert event arrival and for the
remaining duration of the flight,
// no other high severity alert arrive anymore
// This correlation will end-up with a cache clear which will send to the
cache- distributor a message with the parameters
// location=Ny,Invaidate=Yes, resource=flyData
context Ctx select * from pattern [every crewAlertStream(Severity=“high”
and Reason=“medical”) −>
```

( rewAlertStream.win:time(Fly-458-RemainingDuration) and not

(crewAlertStream(Severity=“high” and Reason=“medical”) ) ]
// This rule checks if, after the crewAlert event arrival and for the
remaining duration of the flight a
// SupervisionStream event with a low severity arrives
// Name (in sequence diagram) CR1
context Ctx select * from pattern [every crewAlertStream(Severity=“high”
and Reason=“medical”) −>
(rewAlertStream.win:time(Fly-458-RemainingDuration) and
SupervisionStream(Severity=“low”)) ]
// This rule check if, after the crewAlert event arrival and for the
remaining duration of the flight and
// SupervisionStream event with a low severity arrives,
// followed by a SupervisionStream event with a high severity arrives
// Name (in sequence diagram) CR2
context Ctx select * from pattern [

every crewAlertStream(Severity=“high” and Reason=“medical”) −>

(rewAlertStream.win:time(Fly-458-RemainingDuration) and

SupervisionStream(Severity=“low”)) −>

(rewAlertStream.win:time(Fly-458-RemainingDuration) not

crewAlertStream(Severity=“high”)) ]

### Particular Embodiments

Particular aspects of the present disclosure are described herebelow.

In a particular aspect of the present disclosure, it is disclosed a predictive cache apparatus to control the cache update of a database to which the predictive cache apparatus can be connected, the database being suitable to store data items, the predictive cache apparatus including:
a CEP processor connectable to the database and to a plurality of operational units, the CEP processor being arranged to detect events that can be generated by any one of the database and each of the plurality of operational units, and to generate a cache operation order based on at least one detected event; and
a cache distributor connectable to cache units, said cache distributor being arranged to control the data to be cached in at least one of the cache units based on the cache operation order generated by said CEP processor.

The CEP processor can be configured to detect only events generated by the operational units. Additionally, the CEP processor can be configured to generate cache operation orders based on events generated only by the operational units.

The cache operation order can be based on a correlation of a plurality of events detected by the CEP processor.

The control performed by the cache distributor can include at least one of:
sending a first command to the at least one of said cache units to create or update data in said cache unit based on a data item retrieved from the database, the retrieved data item being included in the first command; and
sending a second command to the at least one of the cache units to delete a data item stored in said cache unit, wherein the second command includes an identifier of the data item to be deleted.

In a particular example, the cache operation order is generated based on a set of correlation rules defined using an event processing language. The predictive cache apparatus can be arranged to store the set of correlation rules. The set of correlation rules can include correlation rules defining a cache operation order to be generated by the CEP controller upon detection of a predefined correlation of detected events.

In a particular example, the cache distributor is arranged to generate and maintain updated a map of the cached data stored in the respective cache units.

In another aspect of the present disclosure, it is disclosed an operational system including:
a predictive cache apparatus as defined above;
cache units arranged to cache data;
a plurality of operational units, each of which being associated with one of the cache units; and
a database operable to store data items.

In still another aspect of the present disclosure, it is disclosed a method of cache prediction to be performed by a predictive cache apparatus to control the cache update of a database to which the predictive cache apparatus can be connected, the database being suitable to store data items, the method including:
detecting, by a CEP processor of said predictive cache apparatus, an event transmitted by any one of the database and one of a plurality of operational units that can be connected to the predictive cache apparatus;
generating, by the CEP controller, a cache operation order based on at least one detected event; and
controlling, by a cache distributor of the predictive cache apparatus, the data to be cached in at least one of the cache units based on the generated cache operation order.

In a particular example, the controlling step includes:
retrieving a data item from the database and sending a first command to the at least one of the cache units to create or update data in said cache unit based on the retrieved data item, the retrieved data item being included in said first command; and
sending a second command to the at least one of the cache units to delete a data item stored in said cache unit, wherein the second command includes an identifier of the data item to be deleted.

The cache operation order can be generated based on a set of correlation rules defined using an event processing language. The generating step can include applying the correlation rules stored in said predictive cache apparatus.

It is also disclosed a computer program including instructions to carry out a method as defined above when the computer program is run on a computer.

Still further, it is disclosed a recording medium readable by a computer, the recording medium storing a computer program including instructions for carrying out a method as defined above.

1. Predictive cache apparatus to control the cache update of a database to which said predictive cache apparatus can be connected, said database being suitable to store data items, said predictive cache apparatus including:
a CEP processor connectable to said database and to a plurality of operational units, said CEP processor being arranged to detect events that can be generated by any one of the database and each of said plurality of operational units, and to generate a cache operation order based on at least one detected event; and
a cache distributor connectable to cache units, said cache distributor being arranged to control the data to be cached in at least one of said cache units based on the cache operation order generated by said CEP processor.

2. Predictive cache apparatus according to claim 1, wherein the cache operation order is based on a correlation of a plurality of events detected by said CEP processor.

3. Predictive cache apparatus according to claim 1, wherein said control performed by the cache distributor includes at least one of:
sending a first command to the at least one of said cache units to create or update data in said cache unit based on a data item retrieved from said database, said retrieved data item being included in the first command; and
sending a second command to the at least one of said cache units to delete a data item stored in said cache unit, wherein the second command includes an identifier of the data item to be deleted.

4. Predictive cache apparatus according to claim 1, wherein said cache operation order is generated based on a set of correlation rules defined using an event processing language.

5. Predictive cache apparatus according to claim 4, wherein said predictive cache apparatus is arranged to store the set of correlation rules.

6. Predictive cache apparatus according to claim 5, wherein the set of correlation rules includes correlation rules defining a cache operation order to be generated by said CEP controller upon detection of a predefined correlation of detected events.

7. Predictive cache apparatus according to claim 1, wherein said cache distributor is arranged to generate and maintain updated a map of the cached data stored in the respective cache units.

8. Operational system including:
a predictive cache apparatus according to claim 1;
cache units arranged to cache data;
a plurality of operational units, each of which being associated with one of said cache units; and
a database operable to store data items.

9. Method of cache prediction to be performed by a predictive cache apparatus to control the cache update of a database to which said predictive cache apparatus can be connected, said database being suitable to store data items, said method including:
detecting, by a CEP processor of said predictive cache apparatus, an event transmitted by any one of the database and one of a plurality of operational units that can be connected to said predictive cache apparatus;
generating, by said CEP controller, a cache operation order based on at least one detected event; and
controlling, by a cache distributor of said predictive cache apparatus, the data to be cached in at least one of said cache units based on the generated cache operation order.

10. Method according to claim 9, wherein said controlling step includes:
retrieving a data item from said database and sending a first command to the at least one of said cache units to create or update data in said cache unit based on said retrieved data item, said retrieved data item being included in said first command; and
sending a second command to the at least one of said cache units to delete a data item stored in said cache unit, wherein the second command includes an identifier of the data item to be deleted.

11. Method according to claim 9, wherein said cache operation order is generated based on a set of correlation rules defined using an event processing language.

12. Method according to claim 11, wherein said generating step includes applying said correlation rules stored in said predictive cache apparatus.

13. Computer program including instructions to carry out a method according to claim 9 when said computer program is run on a computer.

14. Recording medium readable by a computer, said recording medium storing a computer program including instructions for carrying out a method according to claim 9.
